(19) United States
(12) Patent Application Publication
(10) Pub. No.: US 2014/0178602 A1
(43) Pub. Date: Jun. 26, 2014

(54) PULSE THERMAL PROCESSING OF SOLID STATE LITHIUM ION BATTERY CATHODES

(71) Applicants: UT-BATTELLE, LLC, Oak Ridge, TN (US); PLANAR ENERGY DEVICES, INC, Orlando, FL (US)

(72) Inventors: Joseph A. ANGELINI, Oak Ridge, TN (US); Claus DANIEL, Knoxville, TN (US); Chad E. DUTY, Oak Ridge, TN (US); Jane Y. HOWE, Oak Ridge, TN (US); Pooran JOSHI, Oak Ridge, TN (US); Jianlin LI, Knoxville, TN (US); E. Andrew PAYZANT, Oak Ridge, TN (US); Adrian S. SABAU, Oak Ridge, TN (US); David L. WOOD, Knoxville, TN (US); Isaiah OLADEJI, Orlando, FL (US)

(73) Assignees: PLANAR ENERGY DEVICES, INC, Orlando, FL (US); UT-BATTELLE, LLC, Oak Ridge, TN (US)

(21) Appl. No.: 13/724,679

(22) Filed: Dec. 21, 2012

(51) Int. Cl. H01M 4/04; H01M 10/04; C25D 5/50

(52) U.S. Cl. CPC H01M 4/0402; C25D 5/50; H01M 10/04
USPC 427/554; 205/57; 427/553; 427/558; 427/559

(57) ABSTRACT

A method of making a cathode for a battery includes the steps of depositing a precursor cathode film having a first crystallinity profile. The precursor cathode film is annealed by irradiating the precursor cathode film with from 1 to 100 photonic pulses having a wavelength of from 200 nm to 1600 nm, a pulse duration of from 0.01 μs and 5000 μs and a pulse frequency of from 1 nHz to 100 Hz. The photonic pulses are continued until the precursor cathode film has recrystallized from the first crystallinity profile to a second crystallinity profile.

### STATEMENT REGARDING FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates to lithium ion battery cathodes, and more particularly to methods for making solid state lithium ion battery cathodes.

### BACKGROUND OF THE INVENTION

The current methods of producing all-solid-state lithium ion batteries are only suited for small-scale, low power cells and involve high-temperature vacuum techniques. Baseline LiNiₓMn_{y}Co_{z}Al_{1-x-y-z}O₂ (NMCA) and CuS/Cu₂ZnSn(S,Se)₄ (CZSS) cathode nanoparticle films were deposited onto aluminum and stainless steel substrates using a streaming process for electroless electrochemical deposition (SPEED) developed by Planar Energy Devices Corporation (Orlando, Fla.). The Oak Ridge National Laboratory (ORNL) has additionally shown in prior work that advanced photonic processing can be used to anneal conventionally coated cathode metal oxide structures into the active crystalline phase. Planar Energy Devices has also demonstrated SPEED with solid electrolyte layers consisting of LiGaAlSPO₄.

All-solid-state lithium ion batteries are important to automotive and stationary energy storage applications because they would eliminate the problems associated with the safety of the liquid electrolyte in conventional lithium ion batteries and allow for use of lithium metal anodes. However, all-solid-state batteries are currently produced using expensive, energy consuming vacuum methods suited for small electrode sizes. Solid-state transition metal oxide cathode and electrolyte layers currently require about 30-60 minutes at 700-800° C. vacuum processing conditions.

### SUMMARY OF THE INVENTION

A method of making a cathode for a battery includes the steps of depositing a precursor cathode film having a first crystallinity profile. The precursor cathode film is annealed by irradiating the precursor cathode film with from 1 to 100 photonic pulses having a wavelength of from 200 nm to 1600 nm, a pulse duration of from 0.01 μs to 5000 μs and a pulse frequency of from 1 nHz to 100 Hz. The photonic pulses are continued until the precursor cathode film has recrystallized from the first crystallinity profile to a second crystallinity profile.

The first crystallinity profile can be an amorphous phase. The wavelength of the pulses can be from 200 nm to 1200 nm. The pulse duration can be from 50 μs to 5000 μs. The pulse frequency can be from 0.1 Hz to 100 Hz. The irradiating step can comprise from 1 to 50 pulses. The pulse frequency can be from 1 mHz to 10 Hz. The intensity of the pulses can be between 0.1 J/cm² and 20 J/cm².

The pulses can be applied in a programmed irradiation step with at least two different pulse durations. The pulses can be applied to the cathode material in at least one step with each step containing at least one pulse.

The method can further comprise a stabilization step comprising applying a pulse to the cathode material, the pulse selected to remove impurity contents. The impurity contents can comprise at least one selected from the group consisting of carbonates, sulphates, nitrates, water, and organic solvent residue. The cathode material in one aspect does not change phase from the first crystallinity profile to a second crystallinity profile.

The cathode material can have a thickness of from 0.1 to 100 μm. The cathode material can have a thickness of from 10 to 20 μm.

The pulse duration can be ramped upward in increments of between 50 and 500 μs during the irradiating step for cathode film heating. The pulse duration can be ramped downward in increments of between 50 and 500 μs after the primary irradiating step for cathode film cooling.

The cathode film can be at least one selected from the group consisting of LiNiₓMn_{y}Co_{z}Al_{1-x-y-z}O₂ (NMCA), LiCoO₂, LiNiO₂, LiMn₂O₄, LiFePO₄, LiMnPO₄, LiFeₓMn₁₋ₓPO₄, LiNiₓMn_{y}Co_{1-x-y}O₂, and Cu₂ZnSn(S,Se)₄. The cathode film can comprises CuS/Cu₂ZnSn(S,Se)₄ (CZTS).

The cathode film can be subjected to a stabilization step prior to the irradiating step. The stabilization step can comprise heating the cathode film to between 200-400° C. for from 5 to 30 min. The stabilization step can be completed with photonic irradiation at low energy density of 0.1-5.0 J/cm².

The precursor cathode film can be deposited by a deposition process selected from the group consisting of streaming process for electroless electrochemical deposition (SPEED), chemical vapor deposition, and physical vapor deposition.

At least one of the wavelength, pulse duration, and pulse intensity can be varied during the irradiating step according to a predetermined annealing protocol. The annealing step can comprise a first pre-crystallization annealing step and a full crystallization annealing step.

The photonic pulse can be created by a photonic pulse generator. The voltage of the photonic pulse generator can be from 220 to 270V for the pre-crystallization annealing step, and from 300V to 500V for the full crystallization annealing step. The total energy absorbed during each annealing step can be from 0.2 J/cm² to 2000 J/cm².

The battery can be a solid state battery. The battery can be a lithium ion battery.

The depositing step can comprise forming a substantially alkali-free first solution comprising at least one transition metal and at least two ligands; spraying the first solution onto the substrate while maintaining the substrate at a temperature between about 100 and 400° C. to form a first solid film containing the transition metal on the substrate; forming a second solution comprising at least one alkali metal, at least one transition metal, and at least two ligands; spraying the second solution onto the first solid film on the substrate while maintaining the substrate at a temperature between about 100 and 400° C. to form a second solid film containing the alkali metal and at least one transition metal; and heating to a temperature between about 300 and 1000° C. in a selected atmosphere to react the first and second films to form a homogeneous cathode film.

The photonic pulses can be laser pulses. The photonic pulses can alternatively be produced by a spread spectrum pulse generator. The method can further comprise the step of filtering the photonic pulses to permit the passage of only selected wavelengths. The photonic pulses can irradiate an area of the precursor cathode film greater than 1 cm² in a single pulse.

### BRIEF DESCRIPTION OF THE DRAWINGS

There is shown in the drawings embodiments which are presently preferred, it being understood, however, that the invention can be embodied in other forms without departing from the spirit or essential attributes thereof.

FIGS. 1 (a) and (b) are scanning electron microscopy (SEM) images of cathode films using (a) no preheating and (b) with preheating to remove adsorbed H₂O.

FIG. 2 is a plot of x-ray diffraction (XRD) results for several different test samples.

FIG. 3 is a plot of transmission-reflectance-absorbance data for a NMCA stabilized film.

FIG. 4 is a plot of XRD results for samples prepared under differing processing protocols.

FIG. 5 is a plot of XRD results for samples prepared under differing processing protocols.

FIG. 6 is a plot of XRD results for samples processed with 5 pulses.

FIG. 7 is a plot of XRD results for samples processed with 20 pulses.

FIG. 8 is a plot of XRD results for samples processed with 2-step processing.

FIG. 9 is a plot of XRD results for samples processed with 3-step processing.

FIG. 10 is a plot of XRD results for samples prepared with the voltage of the pulse generator limited to 250V.

FIG. 11 is a plot of discharge capacity (μAh/cm²) vs. cycles for 0.067 mA and 3.0-4.8 V at room temperature for several samples.

FIG. 12 is a plot of discharge capacity (μAh/cm²) vs. cycles for 0.133 mA and 3.0-4.8 Vat room temperature for several samples.

FIG. 13 is a plot of discharge capacity (μAh/cm²) vs. cycles for 30 and 3.0-4.8 V for several samples.

FIG. 14 is a plot of X-ray photoelectron spectroscopy (XPS) measurement signals of as-received stabilized NMCA films.

FIG. 15 is a plot of X-ray photoelectron spectroscopy (XPS) measurement signals of pulse-thermal processed NMCA films.

FIG. 16 is a schematic diagram of a process flow for making solid state batteries according to the invention.

### DETAILED DESCRIPTION OF THE INVENTION

A method of making a cathode for a battery includes the steps of depositing a precursor cathode film having a first crystallinity profile. The precursor cathode film is annealed by irradiating the precursor cathode film with from 1 to 100 photonic pulses having a wavelength of from 200 nm to 1600 nm, a pulse duration of from 0.01 μs and 5000 μs and a pulse frequency of from 1 nHz to 100 Hz. The photonic pulses are continued until the precursor cathode film has recrystallized from the first crystallinity profile before photonic treatment to a second crystallinity profile after photonic treatment.

The first crystallinity profile can be an amorphous phase. The first crystallinity profile can also be a mixed profile of amorphous regions and crystalline regions. In one aspect the first crystallinity profile comprises at least 10% amorphous regions, by volume. The second crystallinity profile should have no more than 50% amorphous regions and should be further characterized by X-ray diffraction to determine the extent of recrystallization from the first crystallinity profile. The second crystallinity profile can be at least 50%, 60%, 70%, 80%, or at least 90% more crystalline than the first crystallinity profile, as determined by XRD peak height and width analysis of the primary diffracting peaks of the cathode active material. For example, the second crystallinity profile can have a 50% greater peak height and/or a 50% lower full-width half-maximum distance for LiNiₓMn_{y}Co_{1-x-y}O₂ at 2θ≈8.5° for Mo Kα radiation than does the first crystallinity profile. The cathode material in one aspect does not change phase from the first crystallinity profile to a second crystallinity profile.

The wavelength of the pulses can vary between the range of 200 nm and 1600 nm. The wavelength of the pulses in one aspect can vary between any low value and any high value within this range. The wavelength of the pulses can, for example, be from 200 nm to 1200 nm.

The pulse duration can vary between the range of 0.01 μs and 5000 μs. The pulse duration in one aspect can vary between any low value and any high value within this range. The pulse duration can, for example, be from 50 μs to 5000 μs.

The pulse frequency can vary between the range of from 1 nHz to 100 Hz. The pulse frequency in one aspect can vary between any low value and any high value within this range. The pulse frequency can, for example, be from 0.1 Hz to 100 Hz. The pulse frequency can be from 1 mHz to 10 Hz.

The intensity of the pulses can vary. The intensity of the pulses can be between 0.1 J/cm² and 20 J/cm². The intensity of the pulses in one aspect can vary between any low value and any high value within this range.

The irradiating step can comprise any number of pulses within the range of 1 to 100. The number of pulses in one aspect can vary between any low value and any high value within this range. The number of pulses can, for example, be from 1 to 50 pulses.

The pulses can be applied in a programmed irradiation step with at least two different pulse durations. The pulses can be applied to the cathode material in at least one step with each step containing at least one pulse.

The method can further comprise a stabilization step that heats the cathode material to remove impurity contents. The cathode film can be subjected to the stabilization step prior to the irradiating step. The stabilization step can comprise heating the cathode film to between 200-400° C. for from 5 to 30 min. The stabilization step can be completed with photonic irradiation at low energy density of 0.1-5.0 J/cm². The impurity contents can comprise at least one selected from the group consisting of carbonates, sulphates, nitrates, water, and organic solvent residue.

The thickness of the cathode material can vary. The cathode material in one aspect can have a thickness of from 0.1 to 100 μm. The cathode material in another aspect can have a thickness of from 10 to 20 μm.

The pulse duration can be ramped upward in increments of between 50 and 500 μs during the irradiating step for cathode film heating. The pulse duration can be ramped downward in increments of between 50 and 500 μs after the primary irradiating step for cathode film cooling. Other ramping protocols are possible.

The cathode film can be at least one selected from the group consisting of LiNiₓMn_{y}Co_{z}Al_{1-x-y-z}O₂ (NMCA), LiCoO₂, LiNiO₂, LiMn₂O₄, LiFePO₄, LiMnPO₄, LiFeₓMn₁₋ₓPO₄, LiNiₓMn_{y}Co_{1-x-y}O₂, Li₁₊ₓNi_{y}Mn_{z}Co_{1-x-y-z}O₂, and Cu₂ZnSn(S,Se)₄. The cathode film can comprise CuS/Cu₂ZnSn(S,Se)₄ (CZTS).

The precursor cathode film can be deposited by a deposition process selected from the group consisting of streaming process for electroless electrochemical deposition (SPEED), chemical vapor deposition, and physical vapor deposition. The SPEED process is described in Oladeji U.S. Pat. No. 7,776,705 (Aug. 17, 2010) and Oladeji US Pub 2012/0137508 (Jun. 7, 2012), the disclosures of which are incorporated fully by reference.

The depositing step can comprise forming a substantially alkali-free first solution comprising at least one transition metal and at least two ligands; spraying the first solution onto the substrate while maintaining the substrate at a temperature between about 100 and 400° C. to form a first solid film containing the transition metal on the substrate; forming a second solution comprising at least one alkali metal, at least one transition metal, and at least two ligands; spraying the second solution onto the first solid film on the substrate while maintaining the substrate at a temperature between about 100 and 400° C. to form a second solid film containing the alkali metal and at least one transition metal; and heating to a temperature between about 300 and 1000° C. in a selected atmosphere to react the first and second films to form a homogeneous cathode film.

At least one of the wavelength, pulse duration, and pulse intensity can be varied during the irradiating step according to a predetermined annealing protocol. The annealing step can comprise a first pre-crystallization annealing step and a full crystallization annealing step. The annealing step can be preceded by a pre-heating, or stabilization, step, wherein the sample is heated to generate the first crystalline phase (conversion from purely amorphous precursor precipitates) and remove excess physisorbed solvents (such as water from the atmosphere). The stabilization step may be done in one or two parts: it may be thermally heated in an oven or on a hot-plate only, it may be done with pulse thermal processing at low energy and power, or both. The pre-heating or stabilization step heats the cathode surface to lower temperatures than the first pre-crystallization annealing step or the full crystallization annealing step, in one aspect between about 300-400° C. The advantage of using pulse thermal processing is that the chemisorbed water may also be removed from the cathode surface.

The first pre-crystallization annealing is conducted at higher energy and power than the stabilization step to minimize any stress buildup or stress induced cracks or defects in the thin film layer. The energy of the pre-crystallization annealing step can be between 0.1 J/cm² and 10 J/cm². The power of the first pre-crystallization step can be between 0.5 kW/cm² and 5 kW/cm². The full crystallization annealing is conducted at still higher energy and power to densify the thin film microstructure and induce the desired crystalline phase (full recrystallization) for high performance battery development. The energy of the full-crystallization annealing step can be between 1 J/cm² and 20 J/cm². The power of the first full-crystallization step can be between 1 kW/cm² and 20 kW/cm².

The photonic pulse can be created by a photonic pulse generator. The voltage of the photonic pulse generator can be from 220 to 270V for the pre-crystallization annealing step, and from 300V to 500V for the full crystallization annealing step. The total energy absorbed during each annealing step can be from 0.2 J/cm² to 2000 J/cm². The total energy absorbed during each annealing step can range from any low value to any high value within this range.

The battery can be a solid state battery. The battery can be a lithium ion battery. The application can be automotive, grid storage, consumer electronics, energy harvesting, low-power sensors, smart cards, or any other application requiring chemical energy storage. The size of these lithium ion cells may be from 1 μAh to 100 Ah and may operate between 2.0 V to 5.0 V.

Different photonic pulse generators can be utilized. A suitable photonic pulse generator will be capable of generating the desired characteristics of the photonic pulses, which can be any value between from 1 to 100 photonic pulses, having a wavelength of from 200 nm to 1600 nm, a pulse duration of from 0.01 μs to 5000 μs, a pulse frequency of from 1 nHz to 100 Hz, and a pulse intensity of between 0.1 J/cm² and 20 J/cm².

Different materials will respond advantageously to different pulse characteristics. Some materials will respond preferentially to UV (approximately 200-400 nm), some will respond best to pulses in the visible spectrum (approximately 400-700 nm), while other materials will respond to pulses in the infrared (IR) portion of the spectrum (approximately 700-1600 nm). NMCA, for example, responds best to blue light and far UV. The photonic pulse generator can be a laser with a relative narrow photonic pulse spectrum. In another aspect, the pulse generator can be a spread spectrum photonic pulse generator. A spread spectrum photonic pulse generator as used herein means a photonic pulse generator that is capable of generating single photonic pulses comprised of wavelengths separated by at least 100 nm. For example, a photonic pulse centered at 800 nm would include wavelengths of less than 750 nm and also wavelengths of more than 850 nm, as well as wavelengths between 750-800 nm. One such spread spectrum photonic pulse generator is a plasma arc lamp.

An advantage of a spread spectrum pulse source is that filtering methods can be utilized to deliver to the material preferential wavelengths while filtering out unwanted wavelengths from the spectrum of wavelengths that are produced by the pulse generator. Such filtering can be accomplished with known equipment and without the need to change the more expensive pulse generator itself. Also, spread spectrum sources such as plasma arc lamps are capable of delivering pulses to a much wider area than is possible with a laser. For example, a plasma arc pulse generator can deliver a single pulse to cover an area or spot size of greater than at least 1 cm², 10 cm², or 1 m² without redirecting the photonic pulse source.

A suitable photonic pulse generator is the PulseForge 3300 (Novacentrix, Austin Tex.) with capability of 170-750V set point (10 W/cm² and 0.21 J/cm² to 49 kW/cm² and 2.47 J/cm² output). Another suitable pulse generator is the plasma arc lamp manufactured by Vortek Industries Ltd (Vancouver, Canada) with capability of up to 1000 A set point, peak power density of 20 kW/cm², and a wide range of thermal processing time (0.001 s to 30 s) (Vortek-300 kW and Vortek-750 kW).

### Examples

A number of examples were prepared. Table 1 shows the initial NMCA samples annealed with the PulseForge 3300 using the continuous web mode with constant pulse frequency. The slower the web speed, the higher the number of pulses the samples were exposed to. These initial samples were used to establish the extent of recrystallization that could be achieved with a different number of pulses at maximum power. Table 2 shows the initial NMCA sample annealing conditions used for the Vortek plasma arc lamp. Several different current set points were used up to the maximum level of 1000 A to establish the extent of recrystallization that could be achieved at different energy intensities. Table 3 shows annealing conditions for NMCA samples processed at low energy intensity using the Vortek plasma arc lamp.

Table 4 shows energy and power density annealing conditions for a scan of the full range of PulseForge 3300 voltage set points for NMCA samples, and Table 5 shows a refined set of annealing conditions for NMCA samples between 220-305 V. The latter table was used for subsequent development of the first programmed set point protocols with the PulseForge 3300, which consisted of a single voltage plateau at lower energy and power conditions.

Table 6 shows the annealing conditions used for the Vortek plasma arc lamp for low power and energy NMCA sample processing where a hot-plate preheating (stabilization) step was implemented during the annealing step. This preheating step was found to be particularly necessary for removing adsorbed water inside the pores of the NMCA films.

Table 7 shows annealing conditions for the PulseForge 3300, which were used for NMCA sample damage threshold experiments (to determine how high the voltage set point and energy intensity exposure could be). Table 8 shows the annealing conditions used to verify the effectiveness of long pulse durations using the PulseForge 3300 and for further development of the first generation of programmed annealing protocols. These samples were compared to baseline samples 114 and 121 processed with the Vortek plasma arc lamp at 1000 A and 800 A, respectively. Tables 9-11 show the first, second, and third generations, respectively, of PulseForge 3300 programmed annealing protocols for NMCA samples using single voltage plateaus and long pulse durations. The major variables in these protocols were the voltage set point and number of pulses. Table 12 shows the programmed annealing conditions for the PulseForge 3300 where gradual sample heating (using pulse thermal processing) and gradual cooling (after pulse thermal processing at the maximum voltage plateau) was implemented. This advancement was used to prevent thermal shock and film cracking before and after the high energy exposure at the maximum voltage set point where NMCA recrystallization occurs. Table 13 shows the annealing conditions for the PulseForge 3300 where programmed protocols (implementing the advancements described in Tables 9-12) were used with even higher numbers of pulses at maximum voltage and duration. Finally, Table 14 shows the incorporation of all findings described in Tables 9-13 plus the addition of multiple voltage plateaus, i.e. the addition of set points where the voltage is increased for the previous plateau for a specified number of pulses at maximum duration.

TABLE 1
Samples 1-20: PulseForge FTP Complete, XRD in Progress
NMCA Films, Voltage = 500 V, Time = 400 microseconds, Frequency =
1.9 Hz, Duty Cycle = 1, Air Knife Mode = Auto, Sample Size = 0.75 in ×
0.75 in, Type = Uniform; Peak Power 17.00 kW/cm²

| | | | | Approx. | |
|---|---|---|---|---|---|
| | | | | Number of | |
| ORNL | Web | | | Flashes | Radiant |
| Sample | Speed | Sample | % | per | Exposure |
| ID # | (ft/min) | Type | Nickel | sample | (J/cm²) |
| 1 | 9.1 | 31710-1 | 0 | 2 | 13.76 |
| 2 | 9.1 | 31710-2 | 10 | 2 | 13.76 |
| 3 | 9.1 | 31710-3 | 15 | 2 | 13.76 |
| 4 | 9.1 | 31710-4 | 20 | 2 | 13.76 |
| 5 | 9.1 | 31810-1 | 25 | 2 | 13.76 |
| 6 | 6.3 | 31710-1 | 0 | 3 | 20.64 |
| 7 | 6.3 | 31710-2 | 10 | 3 | 20.64 |
| 8 | 6.3 | 31710-3 | 15 | 3 | 20.64 |
| 9 | 6.3 | 31710-4 | 20 | 3 | 20.64 |
| 10 | 6.3 | 31810-1 | 25 | 3 | 20.64 |
| 11 | 4.2 | 31710-1 | 0 | 4 | 27.52 |
| 12 | 4.2 | 31710-2 | 10 | 4 | 27.52 |
| 13 | 4.2 | 31710-3 | 15 | 4 | 27.52 |
| 14 | 4.2 | 31710-4 | 20 | 4 | 27.52 |
| 15 | 4.2 | 31810-1 | 25 | 4 | 27.52 |
| 16 | 2.8 | 31710-1 | 0 | 7 | 48.16 |
| 17 | 2.8 | 31710-2 | 10 | 7 | 48.16 |
| 18 | 2.8 | 31710-3 | 15 | 7 | 48.16 |
| 19 | 2.8 | 31710-4 | 20 | 7 | 48.16 |
| 20 | 2.8 | 31810-1 | 25 | 7 | 48.16 |

TABLE 2
Samples 21-40: Vortek 500 kW
PAL PTP in Progress, XRD After PTP
NMCA Films, Time = 500 microseconds, Sample Size = 0.75 in × 0.75 in

| ORNL | | | |
|---|---|---|---|
| Sample ID # | Current (A) | Sample Type | % Nickel |
| 21 | 200 | 31710-1 | 0 |
| 22 | 200 | 31710-2 | 10 |
| 23 | 200 | 31710-3 | 15 |
| 24 | 200 | 31710-4 | 20 |
| 25 | 200 | 31810-1 | 25 |
| 26 | 530 | 31710-1 | 0 |
| 27 | 530 | 31710-2 | 10 |
| 28 | 530 | 31710-3 | 15 |
| 29 | 530 | 31710-4 | 20 |
| 30 | 530 | 31810-1 | 25 |
| 31 | 800 | 31710-1 | 0 |
| 32 | 800 | 31710-2 | 10 |
| 33 | 800 | 31710-3 | 15 |
| 34 | 800 | 31710-4 | 20 |
| 35 | 800 | 31810-1 | 25 |
| 36 | 1000 | 31710-1 | 0 |
| 37 | 1000 | 31710-2 | 10 |
| 38 | 1000 | 31710-3 | 15 |
| 39 | 1000 | 31710-4 | 20 |
| 40 | 1000 | 31810-1 | 25 |

TABLE 3
Samples 46-57: Vortek 500 kW PAL
PTP complete 9-3-′10, 4 cm lamp to sample
stage offset-Vert DRO at 2.302, Steel Stage
Block in Standard Large Processing Box
NMCA Films, Time = 500 microseconds, Sample Size = 2 in × 2 in

| ORNL | | | |
|---|---|---|---|
| Sample | | | |
| ID # | Current (A) | Sample Type | % Nickel |
| 46 | 50 | 73010-1 | 15 |
| 47 | 50 | 80210-1 | 20 |
| 48 | 50 | 80210-2 | 25 |
| 49 | 100 | 73010-1 | 15 |
| 50 | 100 | 80210-1 | 20 |
| 51 | 100 | 80210-2 | 25 |
| 52 | 200 | 73010-1 | 15 |
| 53 | 200 | 80210-1 | 20 |
| 54 | 200 | 80210-2 | 25 |
| 55 | 300 | 73010-1 | 15 |
| 56 | 300 | 80210-1 | 20 |
| 57 | 300 | 80210-2 | 25 |

TABLE 4
PulseForge 3300 with 16 mm Diameter Lamp
Tubes, Time = 400 microseconds

| Order of | | Radiant | Peak | % Lamp Max |
|---|---|---|---|---|
| Magnitude | | Exposure | Energy | (16 mm Dia |
| Less | Volts | (J/cm²) | (kW/cm²) | Tubes) |
| 0 | 500 | 6.88 | 17.00 | 19.9 |
| 1 | 305 | 0.70 | 1.70 | 5 |
| 2 | 220 | 0.07 | 0.17 | 2 |
| 3 | 164 | 0.01 | 0.017 | 0.8 |

TABLE 5
Samples 58-85: PulseForge PTP:

| ORNL | | | |
|---|---|---|---|
| Sample | | Sample | |
| ID # | Voltage | Type | % Nickel |
| 58 | 220 | 092710-1 | 15% |
| 59 | none | 092710-1 | 15% |
| 60 | 164 | 092710-1 | 15% |
| 61 | 220 | 092710-1 | 15% |
| 62 | 305 | 092710-1 | 15% |
| 63 | 305 | 092710-1 | 15% |
| 64 | 164 | 092710-1 | 15% |
| 65 | 220 | 092710-1 | 15% |
| 66 | 305 | 092710-1 | 15% |
| 67 | 164 | 092710-1 | 15% |
| 68 | 164 | 091510-1 | 20% |
| 69 | 164 | 091510-1 | 20% |
| 70 | 164 | 091510-1 | 20% |
| 71 | 220 | 091510-1 | 20% |
| 72 | 220 | 091510-1 | 20% |
| 73 | 220 | 091510-1 | 20% |
| 74 | 305 | 091510-1 | 20% |
| 75 | none | 091510-1 | 20% |
| 76 | 305 | 091510-1 | 20% |
| 77 | 164 | 0927W-6 | 25% |
| 78 | 164 | 0927W-6 | 25% |
| 79 | 164 | 0927W-6 | 25% |
| 80 | 220 | 0927W-6 | 25% |
| 81 | 220 | 0927W-6 | 25% |
| 82 | 220 | 0927W-6 | 25% |
| 83 | 305 | 0927W-6 | 25% |
| 84 | 305 | 0927W-6 | 25% |
| 85 | none | 0927W-6 | 25% |

TABLE 6
Samples: Vortek 500 kW
PAL PTP, 4 cm lamp to sample stage
standoff, hot plate sample stage at
200° C. with small environmental
chambers on top NMCA Films, Time =
500 microseconds, Sample Size = 1 in × 1 in

| ORNL | | | | |
|---|---|---|---|---|
| Sample | Current | Time | Sample | % |
| ID # | (A) | (ms) | Type | Nickel |
| 86 | none | none | 092710-2 | 15 |
| 87 | 50 | 500 | 092710-2 | 15 |
| 88 | 50 | 500 | 092710-2 | 15 |
| 89 | 100 | 500 | 092710-2 | 15 |
| 90 | 100 | 500 | 092710-2 | 15 |
| 91 | 200 | 500 | 092710-2 | 15 |
| 92 | 200 | 500 | 092710-2 | 15 |
| 93 | 300 | 500 | 092710-2 | 15 |
| 94 | 300 | 500 | 092710-2 | 15 |
| 95 | none | 500 | 092710-3 | 20 |
| 96 | 50 | 500 | 092710-3 | 20 |
| 97 | 50 | 500 | 092710-3 | 20 |
| 98 | 100 | 500 | 092710-3 | 20 |
| 99 | 100 | 500 | 092710-3 | 20 |
| 100 | 200 | 500 | 092710-3 | 20 |
| 101 | 200 | 500 | 092710-3 | 20 |
| 102 | 300 | 500 | 092710-3 | 20 |
| 103 | 300 | 500 | 092710-3 | 20 |

TABLE 7
NMCA Films, PulseForge 3300, Time = 400 microseconds,
Duty Cycle = 1, Type = Uniform, Air Knife = Auto, Number
of Pulses = 1, Sample Size = 1 in × 1 in

| | | | | Radiant | |
|---|---|---|---|---|---|
| ORNL | | Sample | | Exposure | Peak Power |
| Sample ID # | Voltage | Type | % Nickel | (J/cm²) | (kW/cm²) |
| 104 | None | 092710-5 | 25% | NA | NA |
| 105 | 305 | 092710-5 | 25% | 0.7 | 1.7 |
| 106 | 320 | 092710-5 | 25% | 0.92 | 2.3 |
| 107 | 350 | 092710-5 | 25% | 1.49 | 3.7 |
| 108 | 380 | 092710-5 | 25% | 2.23 | 5.6 |
| 109 | 410 | 092710-5 | 25% | 3.13 | 7.8 |
| 110 | 440 | 092710-5 | 25% | 4.2 | 11 |
| 111 | 395 | 092710-5 | 25% | 2.66 | 6.6 |
| 112 | 425 | 092710-5 | 25% | 3.64 | 9.1 |

TABLE 8
The Vortek 500 kW PAL PTP had a 4 cm lamp to sample stage standoff. Both Vortek and
PulseForge samples were on a hot plate sample stage at 200 degrees Celsius for 20 minutes
before PTP and kept on it during PTP (corresponds to 210° C. setting) inside small
environmental chambers containing Argon. Vortek sample 114 was stored in Nitrogen. 115-
121 were stored and bagged in Argon. PulseForge used 20 mm Diameter Lamp Tubes
NMCA Films, Vortek 500 kW, Sample Size = 1 in × 1 in, Ni Composition = 20%, Argon Gas Environment

| ORNL Sample ID # | Current (A) | Time (ms) | Sample Type |
|---|---|---|---|
| 113 | none | none | 040511-4 |
| 114 | 1,000 | 200 | 040511-4 |

NMCA Films, PulseForge 3300, Ni Composition = 20%, Sample Size = 1 in × 1 in

| | | | | | | Relative | Relative |
|---|---|---|---|---|---|---|---|
| ORNL | | Time | Number of | Pulse | Sample | Peak Power | Radiant Exposure |
| Sample ID # | Voltage | (μs) | Pulses | Rate (Hz) | Type | (kW/cm²) | (J/cm²) |
| 115 | 270 | 3,000 | 1 | NA | 040511-4 | 2.8 | 8.32 |
| 116 | 220 | 5,000 | 1 | NA | 040511-4 | 1.7 | 8.67 |
| 117 | 220 | 5,000 | 9 | 1.8 | 040511-4 | 1.7 | 78.03 |
| 118 | 220 | 5,000 | ~8 | 1.8 | 040511-4 | 1.7 | 69.36 |
| 119 | 270 | 3,000 | 5 | 1.8 | 040511-4 | 2.8 | 41.6 |
| 120 | 270 | 3,000 | 10 | 1.8 | 040511-4 | 2.8 | 83.2 |

| ORNL Sample ID # | Current (A) | Time (ms) | Sample Type |
|---|---|---|---|
| 121 | 800 | 200 | 040511-4 |

TABLE 9

| ORNL | |
|---|---|
| Sample | |
| ID # | PulseForge, Hot Plate, and Furnace Related Recipes |
| 122 | Step pulse duration from 500 μs to 5 ms in 500 us increments at 220 V; 1 pulse at |
| | maximum pulse duration of 5 ms (with hot-plate pre-heating up to 400 deg C.). |
| 123 | Step pulse duration from 500 μs to 5 ms in 500 us increments at 220 V; 5 pulses at |
| | maximum pulse duration of 5 ms (with hot-plate pre-heating up to 400 deg C.). |
| 124 | Step voltage from 150 V up to 220 V in increments of 10 V at 1 ms pulse duration; 5 pulses |
| | at maximum voltage of 220 V at 5 ms pulse duration (with hot-plate pre-heating up to 400 |
| | deg C.). |
| 125 | No pulse thermal processing (with hot-plate pre-heating up to 400 deg C.). |
| 126 | Step pulse duration from 500 μs to 5 ms in 500 us increments at 220 V; 1 pulse at |
| | maximum pulse duration of 5 ms (with furnace heating to 500-575 deg C. for 40 minutes, |
| | then stored in Ar glove box and put on hot plate for 20 minutes at 400 C. before PTP in |
| | chamber in air). |
| 127 | Step pulse duration from 500 μs to 5 ms in 500 us increments at 220 V; 5 pulses at |
| | maximum pulse duration of 5 ms (with furnace heating to 500-575 deg C. for 40 minutes, |
| | then stored in Ar glove box and put on hot plate for 20 minutes at 400 C. before PTP in |
| | chamber in air). |
| 128 | Step voltage from 150 V up to 220 V in increments of 10 V at 1 ms pulse duration; 5 pulses |
| | at maximum voltage of 220 V at 5 ms pulse duration (with furnace heating to 500-575 deg |
| | C. for 40 minutes, then stored in Ar glove box and put on hot plate for 20 minutes at 400 |
| | deg. C. before PTP in chamber in air). |
| 129 | No pulse thermal processing (with furnace heating to 500-575 deg C. for 40 minutes). |
| 130 | Blank (no pre-heating and no pulse thermal processing). |
| 131 | 4″ × 4″ sample-061511-2 cathode LMNCAO (20% Ni), processed on hot plate for 20+ |
| | minutes @ 400 C. |
| 132 | 4″ × 4″ sample-072211-4 cathode LMNCAO (20% Ni), processed in furnace with some air |
| | and argon flow @ 500-570 C. for 40 mins (furnace temp overshot to 570 and had to vent) |

TABLE 10
Hot Plate and PulseForge Thermal Processing in Air (NMCA Samples)

| | | Hot Plate | Ramp up: | Holding | Ramp |
|---|---|---|---|---|---|
| | | Pretreatment: | the | Pulses: the | Down: the |
| | | Common | Common | Common | Common |
| | | Parameters | Parameters | Parameters | Parameters |
| | | 400° C. for | 250 μs to | 1.8 Hz Pulse | 4750 μs to |
| | | ~10 minutes | 4750 μs in | Rate. | 250 μs in |
| | | | 250 μs | | 250 μs |
| | | | steps, at 1.8 Hz | | steps, at |
| | | | Pulse | | 1.8 Hz Pulse |
| | | | Rate | | Rate |
| | Planar | | | Hold Pulses: | Voltage of |
| | Energy | Hot Plate | Voltage of | Number of | Ramp |
| ORNL | Sample | Pretreatment | Ramp Up | Pulses and | Down |
| Sample ID # | Batch ID | (Y/N) | Pulses | Voltage | Pulses |
| | | | | for 5,000 μs | |
| | | | | pulse | |
| | | | | length | |
| 133 | 102811-3 | N | none | none | none |
| 134 | 102811-3 | Y | 220 | 10 pulses, | 220 |
| | | | | 220 V | |
| 135 | 102811-3 | Y | 220 | 15 pulses, | 220 |
| | | | | 220 V | |
| 136 | 102811-3 | Y | 220 | 20 pulses, | 220 |
| | | | | 220 V | |
| 137 | 102811-3 | Y | 220 | 25 pulses, | 220 |
| | | | | 220 V | |
| | | | | for 3,000 us | |
| | | | | pulse | |
| | | | | length | |
| 138 | 102811-3 | Y | 270 | 5 pulses, | 270 |
| | | | | 270 V | |
| 139 | 102811-3 | Y | 270 | 10 pulses, | 270 |
| | | | | 270 V | |
| 140 | 102811-3 | Y | 270 | 15 pulses, | 270 |
| | | | | 270 V | |
| 141 | 102811-3 | Y | 270 | 20 pulses, | 270 |
| | | | | 270 V | |

NMCA Films, Ni Composition = 20%, Sample Size = 1 in × 1 in

TABLE 11
NMCA Films, Sample Size = 0.75 in × 0.75 in

| | Planar | | | |
|---|---|---|---|---|
| ORNL | Energy | | Environmental | |
| Sample | Sample | | Chamber Window | |
| ID # | Batch ID | % Ni | Diameter | PulseForge 3300 Processing |
| 146 | 072211-5 | 20% Ni | N/A | Not Processed |
| 147 | 072211-5 | 20% Ni | 1″ | 220 V std recipe with ramps and 25 pulses, |
| | | | | with preheat: 15+ min on Hot Plate @ 400 C. |
| 148 | 072211-5 | 20% Ni | 1″ | 270 V std recipe with ramps and 20 pulses, |
| | | | | with preheat: 15+ min on Hot Plate @ 400 C. |
| 149 | 072211-5 | 20% Ni | 1.55″ (Full) | 220 V std recipe with ramps and 25 pulses, |
| | | | | with preheat: 15+ min on Hot Plate @ 400 C. |
| 150 | 072211-5 | 20% Ni | 1.55″ (Full) | 270 V std recipe with ramps and 20 pulses, |
| | | | | with preheat: 15+ min on Hot Plate @ 400 C. |
| 151 | 102811-4 | 25% Ni | N/A | Not Processed |
| 152 | 102811-4 | 25% Ni | 1″ | 220 V std recipe with ramps and 25 pulses, |
| | | | | with preheat: 15+ min on Hot Plate @ 400 C. |
| 153 A | 102811-4 | 25% Ni | 1.55″ (Full) | 220 V std recipe with ramps and 25 pulses, |
| | | | | with preheat: 15+ min on Hot Plate @ 400 C. |
| 153 B | 102811-4 | 25% Ni | 1.55″ (Full) | 220 V std recipe with ramps and 25 pulses, |
| | | | | with preheat: 15+ min on Hot Plate @ 400 C. |
| 154 A | 102811-4 | 25% Ni | 1.55″ (Full) | 270 V std recipe with ramps and 20 pulses, |
| | | | | with preheat: 15+ min on Hot Plate @ 400 C. |
| 154 B | 102811-4 | 25% Ni | 1.55″ (Full) | 270 V std recipe with ramps and 20 pulses, |
| | | | | with preheat: 15+ min on Hot Plate @ 400 C. |

TABLE 12
NMCA Films, Planar Energy Batch ID = 102811-4, Ni Composition = 25%,
Environmental Chamber Window Diameter = 1.55 in (Full), Sample Size = 0.75 in × 0.75 in

| | Pulse Forge 3300 Recipe | | | | |
|---|---|---|---|---|---|
| | (in environmental chamber, in air. | | | | |
| | Time of the longest single pulse | | | % | |
| | was arrived at by finding the | Radiant | | Lamp | |
| | maximum time pulse duration for | Exposure | | Max | |
| | the PulseForge given the set | for 1 | | for 1 | |
| | voltage and pulse rate. This | pulse, | Combined | pulse, | Peak |
| | maximum is reached when | the | Radiant | the | Power for |
| | approximately 20% of the “% | longest | Exposure for all | longest | 1 pulse, |
| | Lamp Max that the PulseForge | single | of the longest | single | the longest |
| | displays based on the input | pulse in | pulses in the | pulse | single |
| ORNL | parameters. This is when values | the | recipe (not | in the | pulse in |
| Sample | become yellow or red in caution | recipe | including ramp | recipe | the recipe |
| ID # | on the PulseForge display) | (J/cm²) | pulses)(J/cm²) | (%) | (kW/cm²) |
| 155 | Preheating on 400° C. hot plate | 8.49 | 169.8 | 19.5 | 4.5 |
| | for 15 minutes, then PTP on hot | | | | |
| | plate. All pulses at 320 Volts and | | | | |
| | 1.8 Hz Pulse Rate. Pulses with | | | | |
| | following durations: ramp up | | | | |
| | with 1 pulse at each time at 250, | | | | |
| | 500, 750, 1000, 1250, 1500, and | | | | |
| | 1750 us, then 20 Pulses at 1900 | | | | |
| | us, then ramp down with 1 pulse | | | | |
| | at each time at 1750, 1500, 1250, | | | | |
| | 1000, 750, 500, and 250 us | | | | |
| 156 | Preheating on 400° C. hot plate | 8.53 | 170.6 | 19.6 | 6.1 |
| | for 15 minutes, then PTP on hot | | | | |
| | plate. All pulses at 370 Volts and | | | | |
| | 1.8 Hz Pulse Rate. Pulses with | | | | |
| | following durations: ramp up | | | | |
| | with 1 pulse at each time at 250, | | | | |
| | 500, 750, 1000, and 1250 us, | | | | |
| | then 20 Pulses at 1400 us, then | | | | |
| | ramp down with 1 pulse at each | | | | |
| | timeat 1250, 1000, 750, 500, and | | | | |
| | 250 us. | | | | |
| 157 | Preheating on 400° C. hot plate | 7.41 | 148.2 | 17 | 8.7 |
| | for 15 minutes, then PTP on hot | | | | |
| | plate. All pulses at 420 Volts and | | | | |
| | 1.8 Hz Pulse Rate. Pulses with | | | | |
| | following durations: ramp up | | | | |
| | with 1 pulse at each time at 250, | | | | |
| | 500, and 750 us, then 20 Pulses | | | | |
| | at 850 us, then ramp down with 1 | | | | |
| | pulse at each time at 750, 500, | | | | |
| | and 250 us. | | | | |
| 158 | Preheating on 400° C. hot plate | 6.41 | 128.2 | 18.4 | 14 |
| | for 15 minutes, then PTP on hot | | | | |
| | plate. All pulses at 470 Volts and | | | | |
| | 1.8 Hz Pulse Rate. Pulses with | | | | |
| | following durations: ramp up | | | | |
| | with 1 pulse at 250 us, then 20 | | | | |
| | Pulses at 450 us, then ramp | | | | |
| | down with 1 pulse at 250 us. | | | | |
| 159 | Preheating on 400° C. hot plate | 6.41 | 576.9 | 18.4 | 14 |
| | for 15 minutes, then PTP on hot | | | | |
| | plate. All pulses at 470 Volts and | | | | |
| | 1.8 Hz Pulse Rate. Pulses with | | | | |
| | following durations: ramp up | | | | |
| | with 1 pulse at 250 us, then 90 | | | | |
| | Pulses at 450 us, then ramp | | | | |
| | down with 1 pulse at 250 us. | | | | |
| | (requested 100 pulses 450 us | | | | |
| | long, but PF only ran 90) | | | | |

TABLE 13
Samples 165-197 (NMCA Films), Ni Composition = 20%, Sample Size = 1 in × 1 in;
samples 165 to 204 had preheat of 400 C. on hot plate for 15+ minutes;
processed in environmental chamber in air on PulseForge 3300

| ORNL | Planar | Pre- | |
|---|---|---|---|
| Sample | Energy | Annealing | |
| ID # | Sample ID | Description | Pulse Thermal Processing Conditions |
| 165 | 041812-4 | 10 SPEED | 270 V: Ramp up in 250 μs increments to 3100 μs, |
| | | passes | then 20 pulses at ~3100 us (maximum duration, |
| | | | ~2.5 J/cm2/pulse), then ramp down in 250 μs |
| | | | increments to 250 μs (2 samples). |
| 166 | 041812-4 | 10 SPEED | 270 V: Ramp up in 250 μs increments to 3100 μs, |
| | | passes | then 20 pulses at ~3100 us (maximum duration, |
| | | | ~2.5 J/cm2/pulse), then ramp down in 250 μs |
| | | | increments to 250 μs (2 samples). |
| 167 | 041812-4 | 10 SPEED | 270 V: Ramp up in 250 μs increments to 3100 μs, |
| | | passes | then 40 pulses at ~3100 μs (maximum duration, |
| | | | ~2.5 J/cm2/pulse), then ramp down in 250 μs |
| | | | increments to 250 μs (2 samples). |
| 168 | 041812-4 | 10 SPEED | 270 V: Ramp up in 250 μs increments to 3100 μs, |
| | | passes | then 40 pulses at ~3100 μs (maximum duration, |
| | | | ~2.5 J/cm2/pulse), then ramp down in 250 μs |
| | | | increments to 250 μs (2 samples). |
| 169 | 041812-4 | 10 SPEED | 310 V: Ramp up in 200 μs increments to 2000 μs, |
| | | passes | then 20 pulses at 2000 μs (maximum duration, 3.6 J/cm2/ |
| | | | pulse), then ramp down in 200 μs |
| | | | increments to 200 μs (2 samples). |
| 170 | 041812-4 | 10 SPEED | 310 V: Ramp up in 200 μs increments to 2000 μs, |
| | | passes | then 20 pulses at 2000 μs (maximum duration, 3.6 J/cm2/ |
| | | | pulse), then ramp down in 200 μs |
| | | | increments to 200 μs (2 samples). |
| 171 | 041812-4 | 10 SPEED | 310 V: Ramp up in 200 μs increments to 2000 μs, |
| | | passes | then 40 pulses at 2000 μs (maximum duration, 3.6 J/cm2/ |
| | | | pulse), then ramp down in 200 μs |
| | | | increments to 200 μs (2 samples). |
| 172 | 041812-4 | 10 SPEED | 310 V: Ramp up in 200 μs increments to 2000 μs, |
| | | passes | then 40 pulses at 2000 μs (maximum duration, 3.6 J/cm2/ |
| | | | pulse), then ramp down in 200 μs |
| | | | increments to 200 μs (2 samples). |
| 173 | 041812-3 | 12 SPEED | 360 V: Ramp up in 150 μs increments to 1500 μs, |
| | | passes | then 20 pulses at 1500 μs (maximum duration, 5.4 J/cm2/ |
| | | | pulse), then ramp down in 150 μs |
| | | | increments to 150 μs (2 samples). |
| 174 | 041812-3 | 12 SPEED | 360 V: Ramp up in 150 μs increments to 1500 μs, |
| | | passes | then 20 pulses at 1500 μs (maximum duration, 5.4 J/cm2/ |
| | | | pulse), then ramp down in 150 μs |
| | | | increments to 150 μs (2 samples). |
| 175 | 041812-3 | 12 SPEED | 360 V: Ramp up in 150 μs increments to 1500 μs, |
| | | passes | then 40 pulses at 1500 μs (maximum duration, 5.4 J/cm2/ |
| | | | pulse), then ramp down in 150 μs |
| | | | increments to 150 μs (2 samples). |
| 176 | 041812-3 | 12 SPEED | 360 V: Ramp up in 150 μs increments to 1500 μs, |
| | | passes | then 40 pulses at 1500 μs (maximum duration, 5.4 J/cm2/ |
| | | | pulse), then ramp down in 150 μs |
| | | | increments to 150 μs (2 samples). |
| 177 | 041812-3 | 12 SPEED | 400 V: Ramp up in 100 μs increments to 1000 μs, |
| | | passes | then 20 pulses at 1000 μs (maximum duration, 6.6 J/cm2/ |
| | | | pulse), then ramp down in 100 μs |
| | | | increments to 100 μs (3 samples). |
| 178 | 041812-3 | 12 SPEED | 400 V: Ramp up in 100 μs increments to 1000 μs, |
| | | passes | then 20 pulses at 1000 μs (maximum duration, 6.6 J/cm2/ |
| | | | pulse), then ramp down in 100 μs |
| | | | increments to 100 μs (3 samples). |
| 179 | 041812-3 | 12 SPEED | 400 V: Ramp up in 100 μs increments to 1000 μs, |
| | | passes | then 20 pulses at 1000 μs (maximum duration, 6.6 J/cm2/ |
| | | | pulse), then ramp down in 100 μs |
| | | | increments to 100 μs (3 samples). |
| 180 | 041812-3 | 12 SPEED | 400 V: Ramp up in 100 μs increments to 1000 μs, |
| | | passes | then 40 pulses at 1000 μs (maximum duration, 6.6 J/cm2/ |
| | | | pulse), then ramp down in 100 μs |
| | | | increments to 100 μs (3 samples). |
| 181 | 041712-3 | Annealed @ | 400 V: Ramp up in 100 μs increments to 1000 μs, |
| | | 400 C. | then 40 pulses at 1000 μs (maximum duration, 6.6 J/cm2/ |
| | | | pulse), then ramp down in 100 μs |
| | | | increments to 100 μs (3 samples). |
| 182 | 041712-3 | Annealed @ | 400 V: Ramp up in 100 μs increments to 1000 μs, |
| | | 400 C. | then 40 pulses at 1000 μs (maximum duration, 6.6 J/cm2/ |
| | | | pulse), then ramp down in 100 μs |
| | | | increments to 100 μs (3 samples). |
| 183 | 041712-3 | Annealed @ | 460 V: Ramp up in 100 μs increments to 500 μs, |
| | | 400 C. | then 20 pulses at 500 μs (maximum duration, 8.2 J/cm2/ |
| | | | pulse), then ramp down in 100 μs |
| | | | increments to 100 μs (3 samples). |
| 184 | 041712-3 | Annealed @ | 460 V: Ramp up in 100 μs increments to 500 μs, |
| | | 400 C. | then 20 pulses at 500 μs (maximum duration, 8.2 J/cm2/ |
| | | | pulse), then ramp down in 100 μs |
| | | | increments to 100 μs (3 samples). |
| 185 | 041712-3 | Annealed @ | 460 V: Ramp up in 100 μs increments to 500 μs, |
| | | 400 C. | then 20 pulses at 500 μs (maximum duration, 8.2 J/cm2/ |
| | | | pulse), then ramp down in 100 μs |
| | | | increments to 100 μs (3 samples). |
| 186 | 041712-3 | Annealed @ | 460 V: Ramp up in 100 μs increments to 500 μs, |
| | | 400 C. | then 40 pulses at 500 μs (maximum duration, 8.2 J/cm2/ |
| | | | pulse), then ramp down in 100 μs |
| | | | increments to 100 μs (3 samples). |
| 187 | 041712-3 | Annealed @ | 460 V: Ramp up in 100 μs increments to 500 μs, |
| | | 400 C. | then 40 pulses at 500 μs (maximum duration, 8.2 J/cm2/ |
| | | | pulse), then ramp down in 100 μs |
| | | | increments to 100 μs (3 samples). |
| 188 | 041712-3 | Annealed @ | 460 V: Ramp up in 100 μs increments to 500 μs, |
| | | 400 C. | then 40 pulses at 500 μs (maximum duration, 8.2 J/cm2/ |
| | | | pulse), then ramp down in 100 μs |
| | | | increments to 100 μs (3 samples). |
| 189 | 041712-3 | Hot Plate: | 500 V: Ramp up in 50 μs increments to 250 μs, then |
| | | 400° C./10 min | 20 pulses at 250 μs (maximum duration, |
| | | | 1.79 J/cm2/pulse), then ramp down in 50 μs |
| | | | increments to 100 μs |
| 190 | 041712-3 | Hot Plate: | 500 V: Ramp up in 50 μs increments to 250 μs, then |
| | | 400° C./10 min | 40 pulses at 250 μs (maximum duration, |
| | | | 1.79 J/cm2/pulse), then ramp down in 50 μs |
| | | | increments to 100 μs |
| 191 | 041812-3 | Hot Plate: | 500 V: Ramp up in 50 μs increments to 250 μs, then |
| | | 400° C./10 min | 20 pulses at 250 μs (maximum duration, |
| | | | 1.79 J/cm2/pulse), then ramp down in 50 μs |
| | | | increments to 100 μs |
| 192 | 041812-3 | Hot Plate: | 500 V: Ramp up in 50 μs increments to 250 μs, then |
| | | 400° C./10 min | 40 pulses at 250 μs (maximum duration, |
| | | | 1.79 J/cm2/pulse), then ramp down in 50 μs |
| | | | increments to 100 μs |
| 193 | 041812-4 | Hot Plate: | 500 V: Ramp up in 50 μs increments to 250 μs, then |
| | | 400° C./10 min | 20 pulses at 250 μs (maximum duration, |
| | | | 1.79 J/cm2/pulse), then ramp down in 50 μs |
| | | | increments to 100 μs |
| 194 | 041812-4 | Hot Plate: | 500 V: Ramp up in 50 μs increments to 250 μs, then |
| | | 400° C./10 min | 40 pulses at 250 μs (maximum duration, |
| | | | 1.79 J/cm2/pulse), then ramp down in 50 μs |
| | | | increments to 100 μs |
| 195 | 052512-2 | As received | As Received |
| 196 | 052512-2 | Hot Plate: | 220 V: Ramp up in 500 μs increments from 500 to |
| | | 400° C./10 min | 5000 μs, then 1 pulse at 5000 μs (maximum |
| | | | duration, 0.924 J/cm2/pulse), then ramp down in |
| | | | 500 μs steps to 500 μs |
| 197 | 052512-2 | Hot Plate: | 220 V: Ramp up in 500 μs increments from 500 to |
| | | 400° C./10 min | 5000 μs, then 5 pulses at 5000 μs (maximum |
| | | | duration, 0.924 J/cm2/pulse), then ramp down in |
| | | | 500 μs steps to 500 μs |

The best results in these test runs were 186 and 189. Checked were 173, 175, 177, 180, 183, 190-197.

TABLE 14
Samples 198-215 (NMCA Films), Ni Composition = 20%,
Sample Size = 0.25 in × 0.25 in

| ORNL | Planar | | |
|---|---|---|---|
| Sample | Energy | Pre-Annealing | |
| ID # | Sample ID | Description | Pulse Thermal Processing Conditions |
| 198 | 052512-2 | Hot Plate: | 250 V: Ramp up in 350 μs increments from 350 to |
| | | 400° C./10 min | 3500 μs, then 5 pulses at 3500 μs (maximum |
| | | | duration, 7.94 J/cm2/pulse), then ramp down in 350 μs |
| | | | steps to 350 μs |
| 199 | 052512-2 | Hot Plate: | 300 V: Ramp up in 200 μs increments from 200 to |
| | | 400° C./10 min | 2000 μs then 5 pulses at 2000 μs (maximum |
| | | | duration, 7.90 J/cm2/pulse), then ramp down in 200 μs |
| | | | steps to 200 μs |
| 200 | 052512-2 | Hot Plate: | 350 V: Ramp up in 150 μs increments from 150 to |
| | | 400° C./10 min | 1500 μs then 5 pulses at 1500 μs (maximum |
| | | | duration, 7.85 J/cm2/pulse), then ramp down in 150 μs |
| | | | steps to 150 μs |
| 201 | 052512-2 | Hot Plate: | 400 V: Ramp up in 100 μs increments from 100 to |
| | | 400° C./10 min | 1000 μs then 5 pulses at 1000 μs (maximum |
| | | | duration, 8.3 J/cm2/pulse), then ramp down in 100 μs |
| | | | steps to 100 μs |
| 202 | 052512-2 | Hot Plate: | 450 V: Ramp up in 70 μs increments from 70 to 700 μs |
| | | 400° C./10 min | then 5 pulses at 700 μs (maximum duration, |
| | | | 7.82 J/cm2/pulse), then ramp down in 70 μs steps to |
| | | | 70 μs |
| 203 | 052512-2 | Hot Plate: | 500 V: Ramp up in 50 μs increments from 50 to 200 μs |
| | | 400° C./10 min | then 5 pulses at 200 μs (maximum duration, |
| | | | 4.62 J/cm2/pulse), then ramp down in 50 μs steps to |
| | | | 50 μs |
| 204 | 052512-2 | Hot Plate: | 250 V: Ramp up in 350 μs increments from 350 to |
| | | 400° C./10 min | 3500 μs, then 20 pulses at 3500 μs (maximum |
| | | | duration, 7.94 J/cm2/pulse), then ramp down in 350 μs |
| | | | steps to 350 μs |
| 205 | 052512-2 | Hot Plate: | 350 V: Ramp up in 150 μs increments from 150 to |
| | | 400° C./10 min | 1500 μs then 20 pulses at 1500 μs (maximum |
| | | | duration, 7.85 J/cm2/pulse), then ramp down in 150 μs |
| | | | steps to 150 μs |
| 206 | 052512-2 | Hot Plate: | 450 V: Ramp up in 70 μs increments from 70 to 700 μs |
| | | 400° C./10 min | then 20 pulses at 700 μs (maximum duration, |
| | | | 7.82 J/cm2/pulse), then ramp down in 70 μs steps to |
| | | | 70 μs |
| 207 | 052512-2 | Hot Plate: | As Received |
| | | 400° C./10 min | |
| 208 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 250 V/3500 μs/20 pulses |
| 209 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 300 V/2000 μs/20 pulses |
| 210 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 350 V/1500 μs/20 pulses |
| 211 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 400 V/1000 μs/20 pulses |
| 212 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 450 V/700 μs/20 pulses |
| 213 | 052512-2 | Hot Plate: | Step 1 of 2: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 2: 500 V/200 μs/20 pulses |
| 214 | 052512-2 | Hot Plate: | Step 1 of 3: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 3: 350 V/1500 μs/10 pulses |
| | | | Step 3 of 3: 450 V/700 μs/20 pulses |
| 215 | 052512-2 | Hot Plate: | Step 1 of 3: 220 V: Ramp up in 500 μs increments |
| | | 400° C./10 min | from 500 to 5000 μs, then 5 pulses at 5000 μs |
| | | | (maximum duration, 0.924 J/cm2/pulse), then ramp |
| | | | down in 500 μs steps to 500 μs |
| | | | Step 2 of 3: 350 V/1500 μs/10 pulses |
| | | | Step 3 of 3: 500 V/200 μs/20 pulses |

The invention replaces physical vapor deposition (PVD) and high-temperature furnace annealing with room-temperature atomized spray deposition and photon-based pulse thermal processing (annealing). The processing of the invention involves minutes of room-temperature deposition and <1 min of photon exposure.

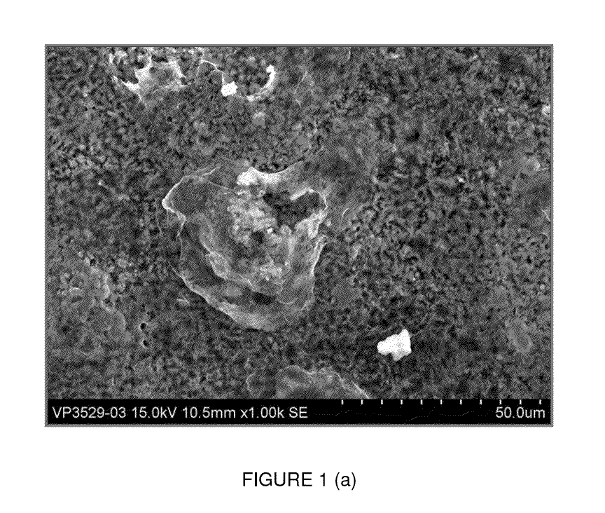

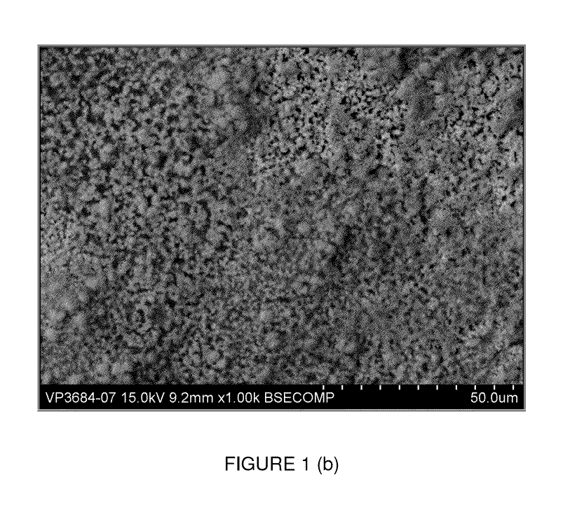

Adsorbed water can cause spallation of the NMCA films during annealing. A pre-heating stabilization step for 5-30 min at 200-400° C. can be implemented. The heat source can be left on during annealing step. Spallation was alleviated. FIGS. 1 (a) and (b) are scanning electron microscopy (SEM) images of cathode films using (a) no preheating and (b) with preheating to remove adsorbed H₂O.

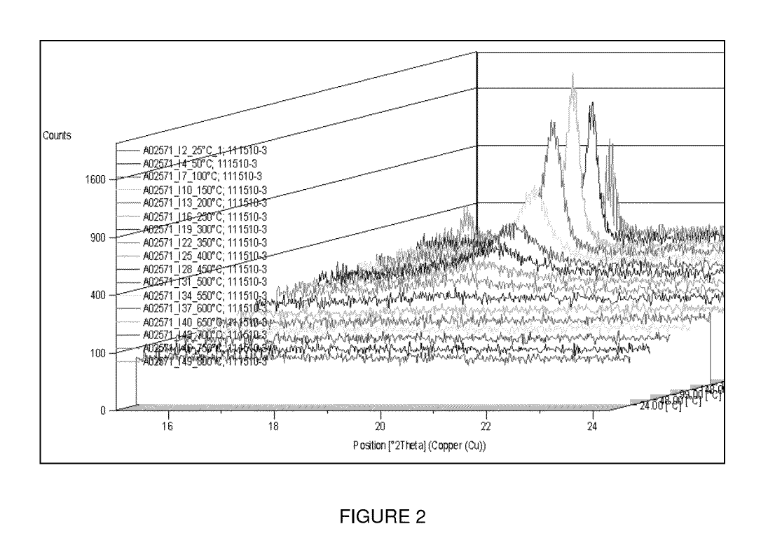

FIG. 2 is a plot of x-ray diffraction (XRD) results for several different test samples. In-situ high-temperature X-ray diffraction (HT-XRD) shows conversion of NMCA precursors to desired crystalline phase (2θ≈18.5°). FIG. 2 also shows that the optimum annealing temperature at 650° C.

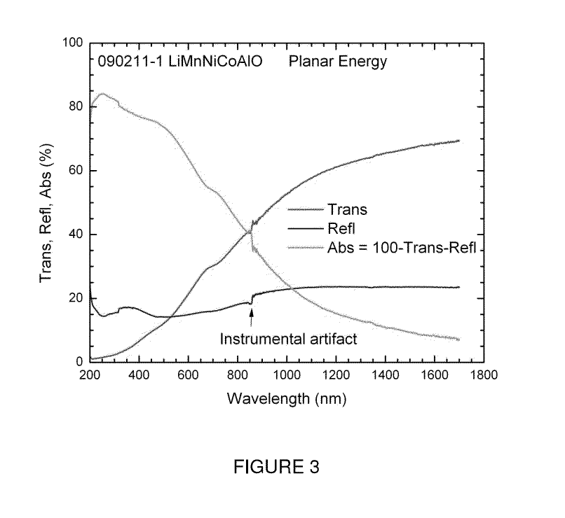

FIG. 3 is a plot of transmission-reflectance-absorbance data for a NMCA stabilized film. The substrate was transparent quartz. This set of measurements allowed for determining the range of wavelengths from the incident radiation that are absorbed by the NMCA material. The results are shown to the left, and it is seen that the maximum absorbance occurs between about 200-1600 nm (far UV to near IR wavelengths). It can be seen that for the NMCA cathode films about 80-85% of the absorbance occurs up to about 1050 nm, suggesting that the majority of the processing energy should be in the UV/visible range.

The following photonic processing protocols were utilized for cathode recrystallization (“single plateau” protocol):

| Vortek Plasma Arc Lamp | PulseForge 3300 |
|---|---|
| ≧800 A | 220-270 V |
| Single pulse | 5-10 pulses at 1.8 Hz |
| 50-200 ms | 3-5 ms |
| | 1.7-2.8 kW/cm² |

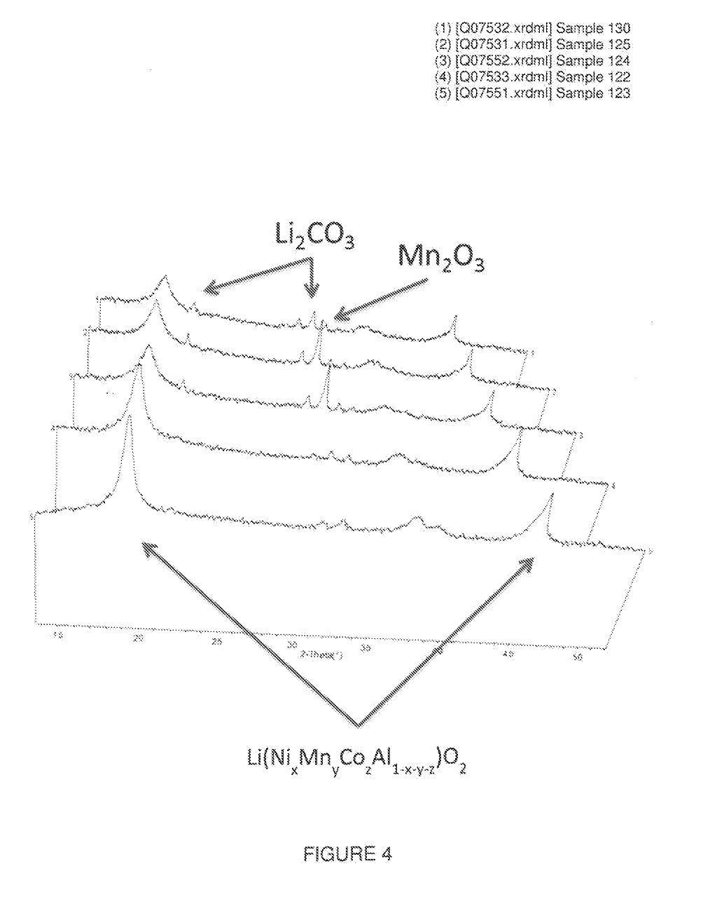

FIG. 4 is a plot of XRD results for samples under differing processing protocols, as follows:
1. 130: As Received
2. 125: Hot Plate
3. 124: 1000 ms at 150, 160, 170, 180, 190, 200, 210V then 5 pulses at 220V/5000 ms
4. 122: 220V/500, 1000, 1500, 2000, 2500, 3000, 3500, 4000, 4500, 5000 ms
5. 123: 220V/500, 1000, 1500, 2000, 2500, 3000, 3500, 4000, 4500, 5×5000 ms

Samples decrease in Li₂CO₃ and increase in Li(NiₓMn_{y}Co_{z}Al_{1-x-y-z})O₂ (NMCA) peak height with photonic processing according to the invention. Samples 122 and 123 show the best recrystallization.

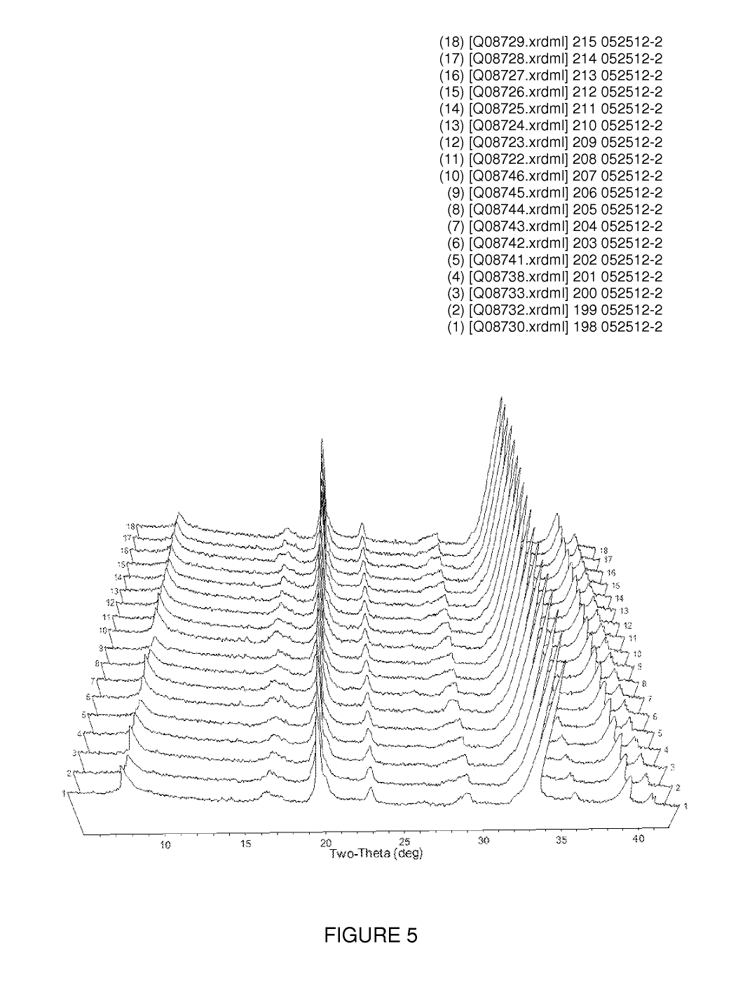

FIG. 5 is a plot of XRD results for NMCA samples prepared under differing processing protocols. 3D XRD Pattern: Planar Energy Samples—052512-2. The samples of interest are 198-200, 204, 205, and 208, as compared to as-received (and stabilized) sample 207. The key comparison for determining the extent of recrystallization after photonic annealing is peak height and width at 2θ≈8.5°, which should be higher and narrower, respectively, for optimum cell performance. Samples 200 and 205 had poor performance.

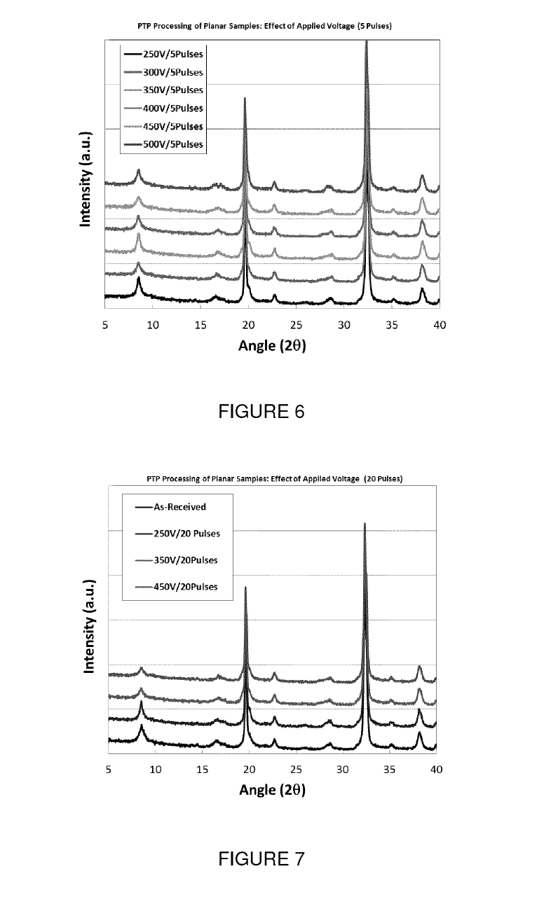

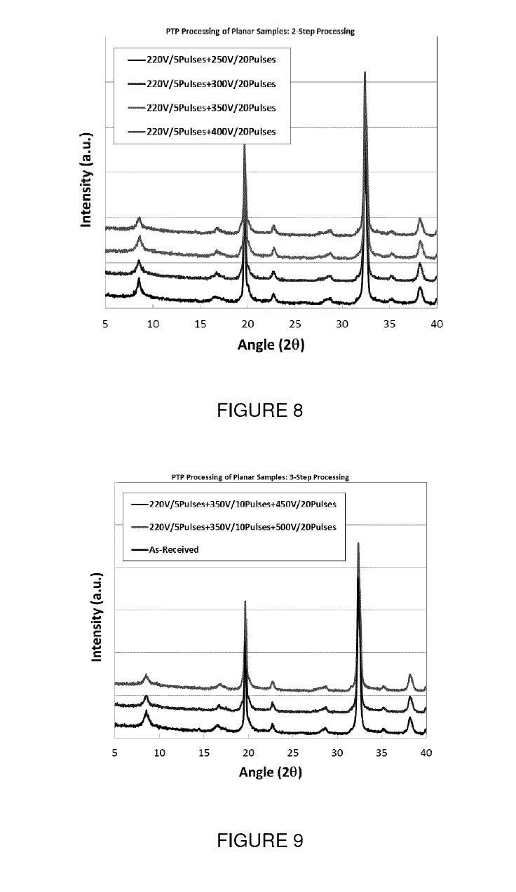

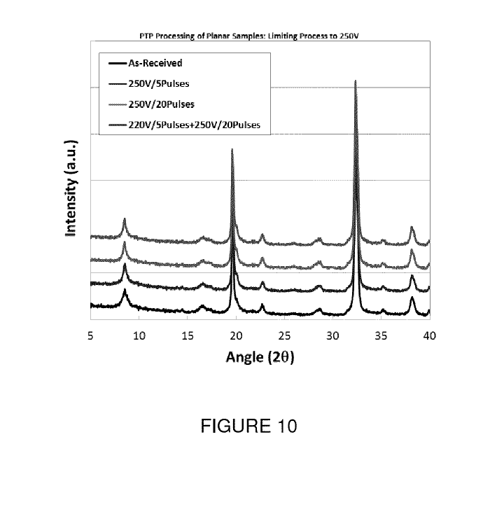

The microstructure and electrical performance of the cathode material and the battery strongly depends on the PTP processing conditions. The key PTP process variables for low thermal budget annealing of the thin films are as follows: applied voltage, pulse duration, and number of pulses. In addition, the PTP system allows the creation of a sequence of pulses with varying amplitude and duration to control the thermal profile for the development of high quality thin films. The impact of the PTP processing conditions on the microstructure of thin films was analyzed by x-ray diffraction technique. FIGS. 6-10 show the results of XRD analysis after pulse thermal processing of NMCA samples (samples 198-215). The key comparison for determining the extent of recrystallization after photonic annealing is peak height and width at 2θ≈8.5°, which should be higher and narrower, respectively, for optimum cell performance. The peak height is representative of the number of crystallites of the desired phase (at 2θ≈8.5°), and peak width is directly proportional to the size of these crystallites. FIG. 6 is a plot of XRD results for samples prepared with 5 pulses (Samples 198-203) while the applied voltage was varied in the range of 250-500V. The XRD patterns show an improvement in crystallinity up to an applied voltage of 350V. A further increase in the applied voltage does not impact the XRD patterns appreciably. FIG. 7 is a plot of XRD results for samples prepared with 20 pulses (Samples 204-207). An increase in the number of pulses at the same voltage does improve the crystallinity of the cathode material up to an applied voltage of about 350V. A further increase in the applied voltage beyond 350V does not result in a significant change in the crystallinity of the material as evaluated by XRD technique. Attempts were made to further improve the PTP process efficiency at lower applied voltages by using a sequence of pulses. FIG. 8 is a plot of XRD results for samples prepared with 2-step processing (Samples 208-211). The 2-step processing also results in improved thin film crystallinity up to an applied voltage of 350V without any introduction of secondary phases. Increasing the applied voltage beyond 350V does not show any further improvement in the XRD peak intensity indicating that the PTP processing at lower applied voltages is effective in improving the crystalline structure of the cathode material. Attempts were made to further improve the PTP thermal budget using a sequence of three pulses (3-step processing). FIG. 9 is a plot of XRD results for samples prepared with 3-step processing (Samples 207, 214, 215). As can be seen from FIG. 9, a 3-step processing is also effective in the creation of crystalline material with controlled microstructure and grain growth. The addition of a higher voltage third step does not result in any further improvement in the XRD pattern as compared to a 2-step processing scheme showing the effectiveness of the PTP technique in processing high performance thin films at low thermal budgets. The impact of the PTP processing at low applied voltages is shown in FIG. 10. FIG. 10 is a plot of XRD results for samples prepared with the voltage of the pulse generator limited to 250V (Samples 207, 198, 204, 208). At lower applied voltage levels; the number of pulses has an appreciable impact on the crystallinity of the cathode material. An improvement in the crystallinity of the material with increasing number of pulses indicates that the temperature profile at low applied voltages is suitable for inducing and controlling crystallinity and grain growth in the cathode material. The following samples were prepared according to the indicated protocols:

| 25% Ni | |
|---|---|
| Samples | Processing Conditions |
| 122 | Step pulse duration from 500 us to 5 ms in 500 us increments |
| | at 220 V; 1 pulse at maximum pulse duration of 5 ms |
| | (with hot-plate pre-heating up to 400 deg C.). |
| 123 | Step pulse duration from 500 us to 5 ms in 500 us increments |
| | at 220 V; 5 pulses at maximum pulse duration of |
| | 5 ms (with hot-plate pre-heating up to 400 deg C.). |
| 124 | Step voltage from 150 V up to 220 V in increments of |
| | 10 V at 1 ms pulse duration; 5 pulses at maximum |
| | voltage of 220 V at 5 ms pulse duration (with |
| | hot-plate pre-heating up to 400 deg C.). |
| 125 | No pulse thermal processing (with hot-plate pre-heating |
| | up to 400 deg C.). |
| 130 | Blank (no pre-heating and no pulse thermal processing). |

These samples were assembled into batteries and tested as indicated below:

| Battery Assembling | Test Procedure |
|---|---|
| Half cell | Constant current charge, I = 0.067 mA or |
| Coin cell | 0.133 mA till V >= 4.8 V |
| 2325 celgard | Constant voltage charge, V = 4.8 V till |
| 1.2M LiFP₆ in EC/DMC | i <= I/2 mA |
| (3/7 wt) | Discharge at I mA till V <= 3 V |
| | Repeat 49 charge-discharge cycles for |
| | a total of 50 cycles |

### Samples: #122-125 &130

D=7.14 mm; Area=0.4 cm²
Current: The current was set at 0.133
mA based on the electrode solid
loading to match the c-rate from the
cells tested at Planar Energy.

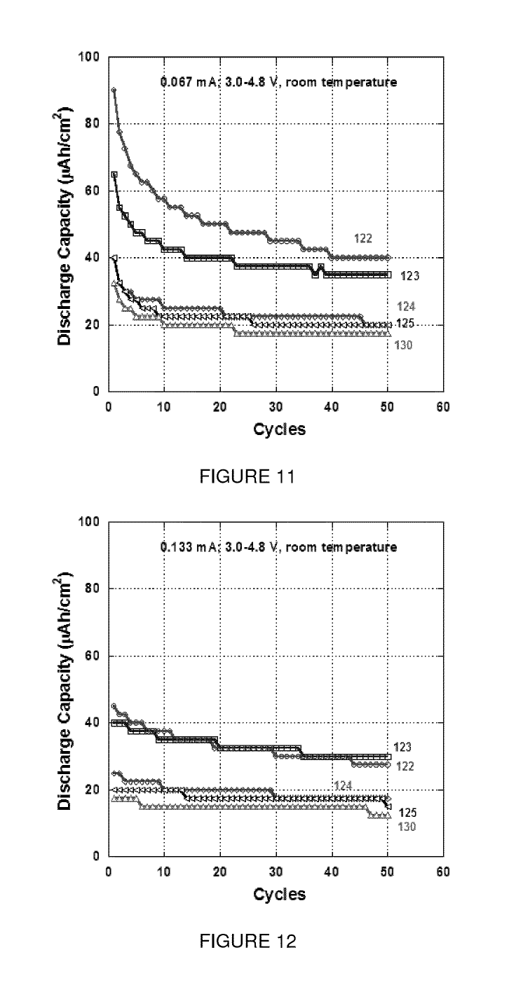

FIG. 11 is a plot of discharge capacity (μAh/cm²) vs. cycles at 0.067 mA/−0.067 mA between 3.0 and 4.8 V at room temperature. FIG. 12 is a plot of discharge capacity (μAh/cm²) vs. cycles at 0.133 mA/−0.133 mA between 3.0 and 4.8 V at room temperature. The capacity is higher with lower C rate, and there is substantially higher performance with photonic annealing. The best performance is at low C rate, for sample 122. Samples 122 and 123 were comparable at the higher C rate (2.0-2.5× the cases with no photonic annealing—samples 125 and 130).

Half cells with samples 198-200 and 204-205 were assembled and tested with the same procedure and protocol as those in [00071] except that the area of electrode was 0.9 cm² instead of 0.4 cm² and the current was set at 30 μA.

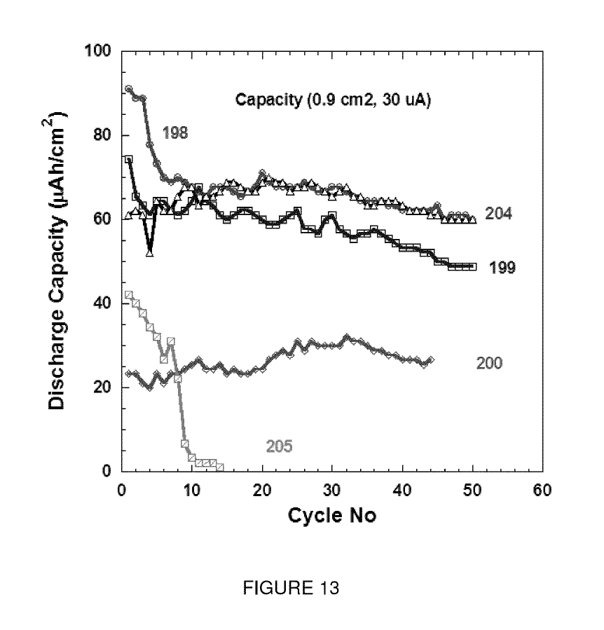

FIG. 13 is a plot of discharge capacity (μAh/cm²) vs. cycles at 0.30 between 3.0 and 4.8 V for several samples. The samples tested were 198, 199, 200, 204, 205, 209 and 214. Samples 209 and 214 exhibited negligible capacity. Significant improvement was observed in samples 198, 199 and 204.

The chemical composition uniformity was preserved after annealing. In the examples identified below the samples were treated with pulses from a Vortek plasma arc lamp. The nominal composition of “15% Ni” sample is Li(Ni_{0.15}Mn_{0.75}CO_{0.05}Al_{0.05})O₂. The Ni:Mn:Co:Al surface ratio was found to be 5:13:1:1, which is slightly Ni rich and Mn deficient. The surface Li:Ni, Li:Mn, Li:Co, and Li:Al ratios were 4:1, 1.4:1, 18:1, and 18:1, respectively. The Li:O ratio was about 1:3 including surface adsorbed O.

(46) 73010-15% Ni (50 A)
Surface Composition (at. %)

| | Al | C | Co | Li | Mn | Ni | O |
|---|---|---|---|---|---|---|---|
| Spot 1 | 1.0 | 8.4 | 1.4 | 17.8 | 13.8 | 4.8 | 52.8 |
| Spot 2 | 1.0 | 8.0 | 1.3 | 19.5 | 13.7 | 4.5 | 52.1 |
| Spot 3 | 1.0 | 7.7 | 1.3 | 20.5 | 13.4 | 4.5 | 51.7 |
| Spot 4 | 1.2 | 7.6 | 1.3 | 20.8 | 13.2 | 4.5 | 51.5 |
| Spot 5 | 1.1 | 8.2 | 1.3 | 20.9 | 12.9 | 4.6 | 51.1 |
| Average | 1.1 | 8.0 | 1.3 | 19.9 | 13.4 | 4.6 | 51.8 |

(49) 73010-15% Ni (100 A)
Surface Composition (at. %)

| | Al | C | Co | Li | Mn | Ni | O |
|---|---|---|---|---|---|---|---|
| Spot 1 | 1.2 | 10.2 | 1.3 | 21.9 | 11.8 | 3.7 | 50.0 |
| Spot 2 | 1.0 | 10.2 | 1.4 | 15.8 | 12.9 | 4.0 | 54.8 |
| Spot 3 | 1.2 | 9.8 | 1.3 | 20.8 | 12.0 | 3.8 | 51.2 |
| Spot 4 | 1.4 | 9.4 | 1.3 | 19.6 | 12.4 | 4.1 | 51.9 |
| Spot 5 | 1.0 | 8.8 | 1.3 | 17.8 | 13.1 | 4.4 | 53.6 |
| Average | 1.1 | 9.7 | 1.3 | 19.2 | 12.4 | 4.0 | 52.3 |

(52) 73010-15% Ni (200 A)
Surface Composition (at. %)

| | Al | C | Co | Li | Mn | Ni | O |
|---|---|---|---|---|---|---|---|
| Spot 1 | 1.2 | 9.2 | 1.1 | 20.0 | 12.9 | 4.8 | 50.9 |
| Spot 2 | 1.0 | 9.2 | 1.2 | 15.8 | 13.9 | 5.0 | 53.9 |
| Spot 3 | 1.5 | 8.9 | 1.2 | 15.9 | 13.5 | 4.9 | 54.1 |
| Spot 4 | 1.1 | 8.8 | 1.3 | 19.5 | 12.8 | 4.8 | 51.8 |
| Spot 5 | 1.4 | 8.3 | 1.3 | 17.5 | 13.3 | 5.0 | 53.4 |
| Average | 1.2 | 8.9 | 1.2 | 17.7 | 13.3 | 4.9 | 52.8 |

(55) 73010-15% Ni (300 A)
Surface Composition (at. %)

| | Al | C | Co | Li | Mn | Ni | O |
|---|---|---|---|---|---|---|---|
| Spot 1 | 1.2 | 8.6 | 1.4 | 18.6 | 13.1 | 6.2 | 51.1 |
| Spot 2 | 1.1 | 7.7 | 1.4 | 19.9 | 13.4 | 5.7 | 50.9 |
| Spot 3 | 0.8 | 6.8 | 1.3 | 18.9 | 13.9 | 5.5 | 52.9 |
| Spot 4 | 1.2 | 6.7 | 1.4 | 14.5 | 14.9 | 6.0 | 55.3 |
| Spot 5 | 1.1 | 7.3 | 1.3 | 16.5 | 14.5 | 5.3 | 53.9 |
| Average | 1.1 | 7.4 | 1.3 | 17.7 | 14.0 | 5.7 | 52.8 |

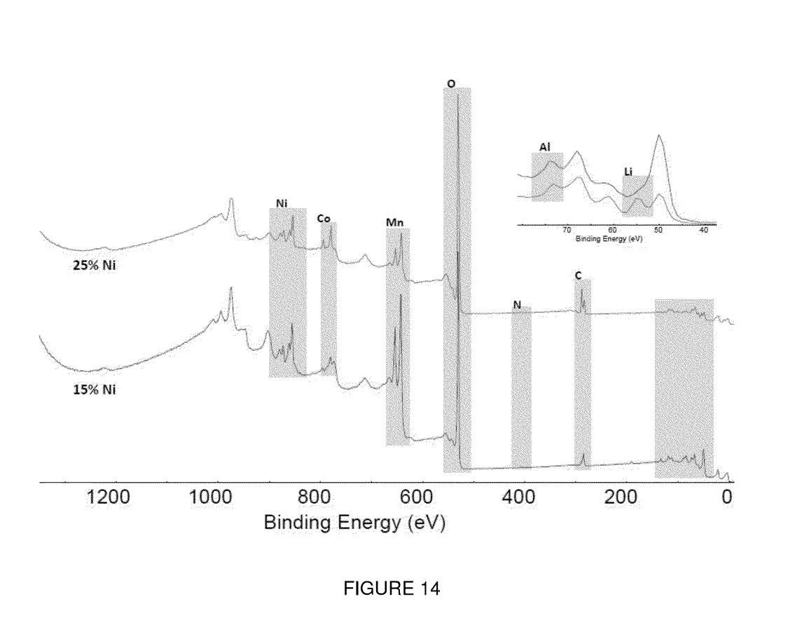

FIG. 14 is a plot of X-ray photoelectron spectroscopy (XPS) measurement signals of as-received stabilized NMCA films. The XPS data demonstrates compositional uniformity.

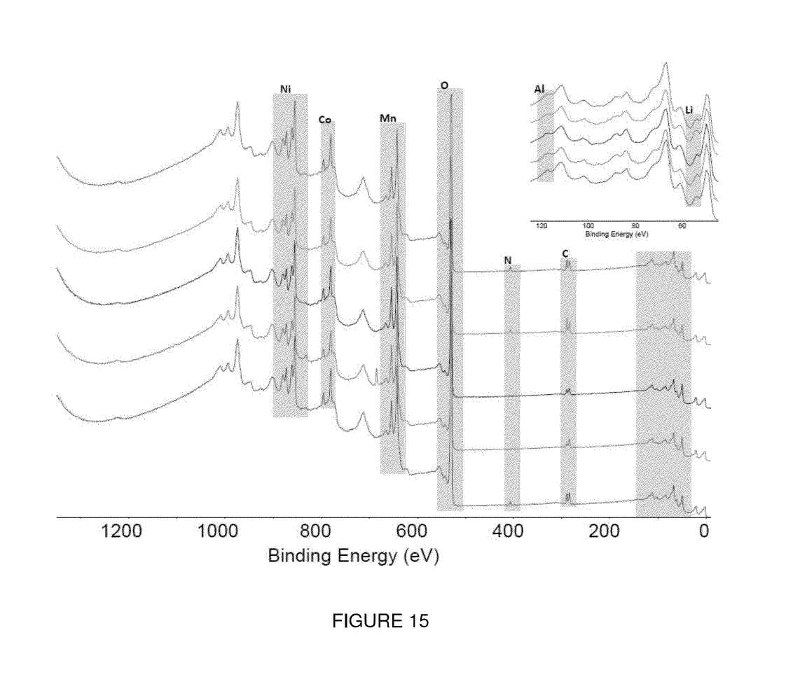

FIG. 15 is a plot of XPS measurement signals of pulse thermal processed (annealed with PulseForge 3300) NMCA films demonstrating compositional uniformity.

Summary table of XPS compositional uniformity

Surface Composition (at. %)

| | Al | C | Co | Li | Mn | N | Ni | O | F |
|---|---|---|---|---|---|---|---|---|---|
| 15% | 3.6 | 11.2 | 0.4 | 0.0 | 12.4 | 0.2 | 5.9 | 64.5 | 1.7 |
| 25% | 1.4 | 18.3 | 1.2 | 18.5 | 2.4 | 0.4 | 3.0 | 54.8 | 0.0 |
| #130 | 0.9 | 13.0 | 1.7 | 8.0 | 5.5 | 1.0 | 8.8 | 61.2 | 0.0 |
| #122 | 0.9 | 10.3 | 1.6 | 9.1 | 7.8 | 0.1 | 9.0 | 58.4 | 2.9 |
| #123 | 0.6 | 9.0 | 2.1 | 9.5 | 8.2 | 0.2 | 8.7 | 61.8 | 0.0 |
| #124 | 0.4 | 13.6 | 1.4 | 11.9 | 5.2 | 1.0 | 6.6 | 59.9 | 0.0 |
| #125 | 0.8 | 11.8 | 1.7 | 7.8 | 5.4 | 1.2 | 9.4 | 62.0 | 0.0 |

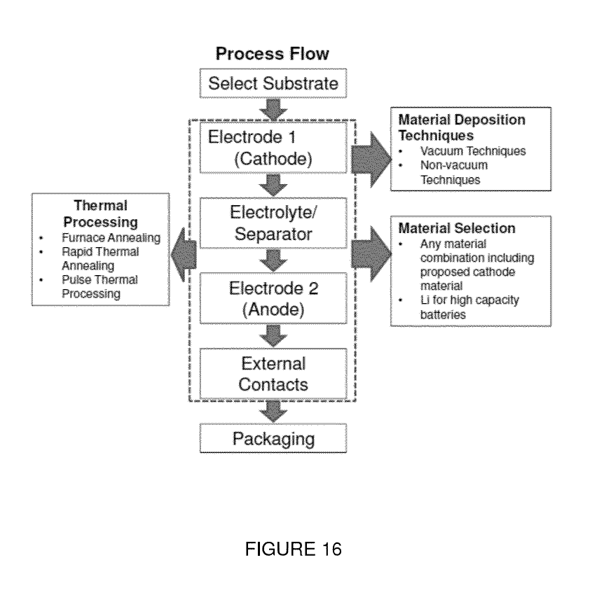

FIG. 16 is an illustration of process flow for making solid-state batteries according to the invention. The substrate is selected, and then the first electrode (cathode) is deposited using material deposition techniques such as vacuum techniques and non-vacuum techniques. The electrolyte/separator is then deposited. The next electrode (anode) is then deposited. The material can be any material combination including the proposed cathode material. The anode and cathode materials can be thermally processed by the furnace annealing, rapid thermal annealing, or pulse thermal processing.

This invention can be embodied in other forms without departing from the spirit or essential attributes thereof and, accordingly, reference should be had to the following claims rather than the foregoing specification as indicating the scope of the invention.

We claim:

1. A method of making a cathode for a battery, comprising the steps of:
depositing a precursor cathode film having a first crystallinity profile;
annealing the precursor cathode film by irradiating the precursor cathode film with from 1 to 100 photonic pulses having a wavelength of from 200 nm to 1600 nm, a pulse duration of from 0.01 μs and 5000 μs and a pulse frequency of from 1 nHz to 100 Hz;
continuing the photonic pulses until the precursor cathode film has recrystallized from the first crystallinity profile to a second crystallinity profile.

2. The method of claim 1 wherein the first crystallinity profile is an amorphous phase.

3. The method of claim 1, wherein the wavelength of the pulses is from 200 nm to 1200 nm.

4. The method of claim 1, wherein the pulse duration is from 50 μs to 5000 μs.

5. The method of claim 1 wherein the pulse frequency is from 0.1 Hz to 100 Hz.

6. The method of claim 1, wherein the irradiating step comprises from 1 to 50 pulses.

7. The method of claim 1, wherein the pulse frequency is from 1 mHz to 10 Hz.

8. The method of claim 1, wherein the intensity of the pulses is between 0.1 J/cm² and 20 J/cm².

9. The method of claim 1, wherein the pulses are applied in a programmed irradiation step with at least two different pulse durations.

10. The method of claim 1, wherein the pulses are applied to the cathode material in at least one step with each step containing at least one pulse.

11. The method of claim 1, further comprising a stabilization step comprising applying a pulse to the cathode material, the pulse selected to remove impurity contents.

12. The method of claim 11, wherein the impurity contents comprise at least one selected from the group consisting of carbonates, sulphates, nitrates, water, and organic solvent residue.

13. The method of claim 1, wherein the cathode material does not change phase from the first crystallinity profile to a second crystallinity profile.

14. The method of claim 1 wherein the cathode material has a thickness of from 0.1 to 100 μm.

15. The method of claim 1, wherein the cathode material has a thickness of from 10 to 20 μm.

16. The method of claim 1, wherein the pulse duration is ramped upward in increments of between 50 and 500 μs during the irradiating step for cathode film heating.

17. The method of claim 1, wherein the pulse duration is ramped downward in increments of between 50 and 500 μs after the primary irradiating step for cathode film cooling.

18. The method of claim 1, wherein the cathode film is at least one selected from the group consisting of LiNiₓMn_{y}Co_{z}Al_{1-x-y-z}O₂ (NMCA). LiCoO₂, LiNiO₂, LiMn₂O₄, LiFePO₄, LiMnPO₄, LiFeₓMn₁₋ₓPO₄, LiNiₓMn_{y}Co_{1-x-y}O₂, Li₁₋ₓNi_{y}Mn_{z}Co_{1-x-y-z}O₂, and Cu₂ZnSn(S,Se)₄.

19. The method of claim 1, wherein the cathode film comprises CuS/Cu₂ZnSn(S,Se)₄ (CZTS).

20. The method of claim 1, wherein the cathode film is subjected to a stabilization step prior to the irradiating step.

21. The method of claim 20, wherein the stabilization step comprises heating the cathode film to between 200-400° C. for from 5 to 30 min.

22. The method of claim 20, wherein the stabilization step is completed with photonic irradiation at low energy density of 0.1-5.0 J/cm².

23. The method of claim 1, wherein the precursor cathode film is deposited by a deposition process selected from the group consisting of streaming process for electroless electrochemical deposition (SPEED), chemical vapor deposition, and physical vapor deposition.

24. The method of claim 1, wherein at least one of the wavelength, pulse duration, pulse intensity, are varied during the irradiating step according to a predetermined annealing protocol.

25. The method of claim 1, wherein the annealing step comprises a first pre-crystallization annealing step and a full crystallization annealing step.

26. The method of claim 25, the photonic pulse is created by a photonic pulse generator, and the voltage of the photonic pulse generator is from 220 to 270V for the pre-crystallization annealing step, and from 300V to 500V for the full crystallization annealing step.

27. The method of claim 1, wherein the total energy absorbed during each annealing step is from 0.2 J/cm² to 2000 J/cm².

28. The method of claim 1, wherein the battery is a solid state battery.

29. The method of claim 28, wherein the battery is a lithium ion battery.

30. The method of claim 1, wherein the depositing step comprises forming a substantially alkali-free first solution comprising at least one transition metal and at least two ligands; spraying the first solution onto the substrate while maintaining the substrate at a temperature between about 100 and 400° C. to form a first solid film containing the transition metal on the substrate; forming a second solution comprising at least one alkali metal, at least one transition metal, and at least two ligands; spraying the second solution onto the first solid film on the substrate while maintaining the substrate at a temperature between about 100 and 400° C. to form a second solid film containing the alkali metal and at least one transition metal; and heating to a temperature between about 300 and 1,000° C. in a selected atmosphere to react the first and second films to form a homogeneous cathode film.

31. The method of claim 17, wherein the cathode is incorporated in a solid state lithium battery having a capacity greater than 200 mAh/g.

32. The method of claim 1, wherein the photonic pulses are laser pulses.

33. The method of claim 1, wherein the photonic pulses are produced by a spread spectrum pulse generator.

34. The method of claim 33, further comprising the step of filtering the photonic pulses to permit the passage of only selected wavelengths.

35. The method of claim 33, wherein the photonic pulses irradiate an area of the precursor cathode film greater than 1 cm² in a single pulse.
